(19) United States
(12) Patent Application Publication
(10) Pub. No.: US 2018/0217321 A1
(43) Pub. Date: Aug. 2, 2018

(54) PLANAR LIGHT SOURCE DEVICE AND DISPLAY DEVICE

(71) Applicant: Mitsubishi Electric Corporation, Tokyo (JP)

(72) Inventor: Shigeyuki MATSUMOTO, Tokyo (JP)

(73) Assignee: Mitsubishi Electric Corporation, Tokyo (JP)

(21) Appl. No.: 15/858,530

(22) Filed: Dec. 29, 2017

(30) Foreign Application Priority Data
Jan. 31, 2017 (JP) 2017-015384

(51) Int. Cl. F21V 8/00

(52) U.S. Cl. CPC G02B 6/0091; G02B 6/0085; G02B 6/0055

(57) ABSTRACT

At a time of engagement between a protruding portion of a rear frame and a recessed portion of a light guide plate, two continuous side surfaces forming a corner portion where the protruding portion of the rear frame is disposed, that is, a first side surface and a second side surface, are arranged in contact with or close to corresponding third side surface and fourth side surface of the light guide plate in a manner facing the third side surface and the fourth side surface.

### BACKGROUND OF THE INVENTION

### Field of the Invention

The present invention relates to a planar light source device and a display device provided with the planar light source device.

### Description of the Background Art

In recent years, display devices such as liquid crystal displays (LCD) are widely used for various purposes due to their advantages such as light weight and thinness. A liquid crystal display panel mounted on a liquid crystal display includes a glass substrate on which wirings and electrodes are formed and a counter substrate, which are disposed in parallel to each other, and a liquid crystal is sandwiched between the substrates. A polarizer is attached to a surface of each substrate. A display region of the liquid crystal display panel is formed from a large number of pixels, and an image is displayed when a signal according to a display image is applied to each pixel. The display image is viewed by an observer when light is radiated by a planar light source device installed on a rear surface of the liquid crystal display panel.

As described above, a liquid crystal display is a so-called light-receiving display device configured from a liquid crystal display panel for which light transmittance is controlled for each pixel, and a planar light source device for irradiating the liquid crystal display panel, and is used for various purposes that make use of such characteristics. For example, such a display is used as a display of a personal computer, a display device of devices used for industrial purposes, and an in-vehicle display device, and a display device which is capable of performing display in a wide temperature range and under a condition of strong vibration is desired especially for the purpose of mounting on a vehicle or for use in a construction machine.

A planar light source device is configured from a light source for emitting light, a light guide plate for propagating light from the light source in a planar manner, and a frame for housing the light source and the light guide plate. With a conventional planar light source device, to absorb expansion and contraction of the light guide plate caused by temperature variations, a gap (hereinafter referred to as “clearance”) has to be provided between the light guide plate and the frame, but this causes the light guide plate to move inside the frame when vibration or impact is applied, which results in occurrence of rattle noise which is caused by wobbling between the light guide plate and a peripheral member.

The light guide plate of a general planar light source device includes a plurality of protruding portions (hereinafter referred to as “light guide plate ear portions”) on a side surface of the light guide plate, and the light guide plate is held by sandwiching the light guide plate ear portions in the frame or the like. Furthermore, a structure of fixation by use of an adhesive tape or the like, and a structure of providing an elastic component between the light guide plate and the frame and pressing and holding the light guide plate in one direction to thereby fix the light guide plate to the frame are also used, for example.

Japanese Patent Application Laid-Open No. 2008-78010 discloses a technique of holding a light guide plate of a backlight unit by providing a protruding or recessed rib portion on a side end surface of the light guide plate and providing an elastically deformable pressing member on a frame facing the protruding or recessed rib portion. Such a structure suppresses breakage of a light source due to movement of the light guide plate, wear of the light guide plate, rattle noise caused by wobbling between the light guide plate and a peripheral member in a highly vibrating environment, a change in brightness, and the like.

Furthermore, Japanese Patent Application Laid-Open No. 2009-76357, Japanese Patent Application Laid-Open No. 2008-27736, and Japanese Patent Application Laid-Open No. 2009-158233 disclose techniques of holding a light guide plate using an outer shape of the light guide plate, without providing a light guide plate ear portion. There are disclosed a technique of holding a light guide plate by attaching elastic members for holding a light source to two corner portions of the light guide plate, a technique of holding a light guide plate by providing metal springs or resin elastic members on two side surfaces of the light guide plate, and a technique of bending a reflective sheet into an elastic member to thereby press a light guide plate to one side of a frame and hold the light guide plate.

Japanese Patent Application Laid-Open No. 2015-133189 discloses a structure of providing a protruding portion to a frame which is disposed at a light guide plate ear portion, forming an inclined surface at a tip of the protruding portion, and fixing the protruding portion with a recessed portion of a light guide plate. Such a structure suppresses movement of the light guide plate and prevents breakage of a fixing portion at a time of application of a strong impact on a display device.

However, according to the technique described in Japanese Patent Application Laid-Open No. 2008-78010, a light guide plate ear portion has to be provided, and it is difficult to slim down a border of a liquid crystal display device.

According to the techniques described in Japanese Patent Application Laid-Open No. 2009-76357 and Japanese Patent Application Laid-Open No. 2008-27736, occurrence of rattle noise which is caused by fluttering of the light guide plate in the frame at a position where the elastic member is not disposed, in an environment where strong vibration or impact is applied, cannot be suppressed, and there is a problem that higher resonance frequency vibration is caused.

According to the technique described in Japanese Patent Application Laid-Open No. 2009-158233, the force of holding the light guide plate is gradually reduced over time, and there is a problem that a long-term effect of suppressing rattle noise is difficult to achieve.

According to the technique described in Japanese Patent Application Laid-Open No. 2015-133189, while the structure prevents breakage of the fixing portion, occurrence of rattle noise which is caused by wobbling between the light guide plate and the frame is difficult to suppress in a use environment where vibration or impact is constantly applied to the light guide plate.

Additionally, a method of bonding and fixing the light guide plate to the frame with an adhesive tape or the like is also disclosed, but this makes assembly and disassembly difficult, and there is a problem that re-use of a member is difficult. In the case of use in an environment where a temperature range is wide and where vibration or impact is constantly applied, such as in the case of use for vehicles, vessels, and construction machines, there is a problem that the fixing force of an adhesive material is reduced or the adhesive tape is peeled off due to the physical property of an adhesive material being greatly changed, and also, due to an influence of expansion and contraction of a peripheral member.

### SUMMARY

The present invention has its object to suppress occurrence of rattle noise which is caused by wobbling between a light guide plate and a peripheral member, even in a use environment with a wide temperature range and in a use environment where vibration or impact is constantly applied.

A planar light source device of the present invention is a planar light source device including a light source, a light guide plate for emitting light from the light source from an emitting surface, the light guide plate including at least two side surfaces that are continuous to the emitting surface, and a frame for housing on an inside the light source and the light guide plate, the frame including a bottom surface and side surfaces that are continuous to the bottom surface, where the frame includes, near a corner portion formed by two of the side surfaces, a protruding portion protruding toward the inside from the bottom surface, a recessed portion for engaging with the protruding portion is formed to the light guide plate, on a counter-emitting surface opposite the emitting surface of the light guide plate and at a position where the protruding portion is disposed, and at least two of side surfaces of the light guide plate are arranged facing the two side surfaces forming the corner portion of the frame.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a display device according to the present invention;

FIG. 2 is an exploded perspective view of a planar light source device according to the present invention;

FIGS. 3A to 3C are a front view and cross-sectional views of the display device according to the present invention;

FIGS. 4A and 4B are a front view of the planar light source device according to the present invention, and an enlarged view of main parts of the planar light source device;

FIG. 5 is an enlarged view of main parts of a rear frame according to the present invention; and

FIG. 6 is an enlarged view of main parts of a light guide plate according to the present invention.

### DESCRIPTION OF THE PREFERRED EMBODIMENTS

### Preferred Embodiment

<Configuration of Display Device>

Hereinafter, a preferred embodiment of a planar light source device and a display device of the present invention will be described with reference to the drawings. Additionally, in the following description, a same reference sign indicates a same or substantially same structural element. Accordingly, a detailed description thereof may be omitted. Furthermore, a dimension, a material, a shape, an arrangement position and the like of each structural element indicated in the present preferred embodiment are changed as appropriate depending on a configuration of a device to which the present invention is applied and various conditions, and are not restrictive.

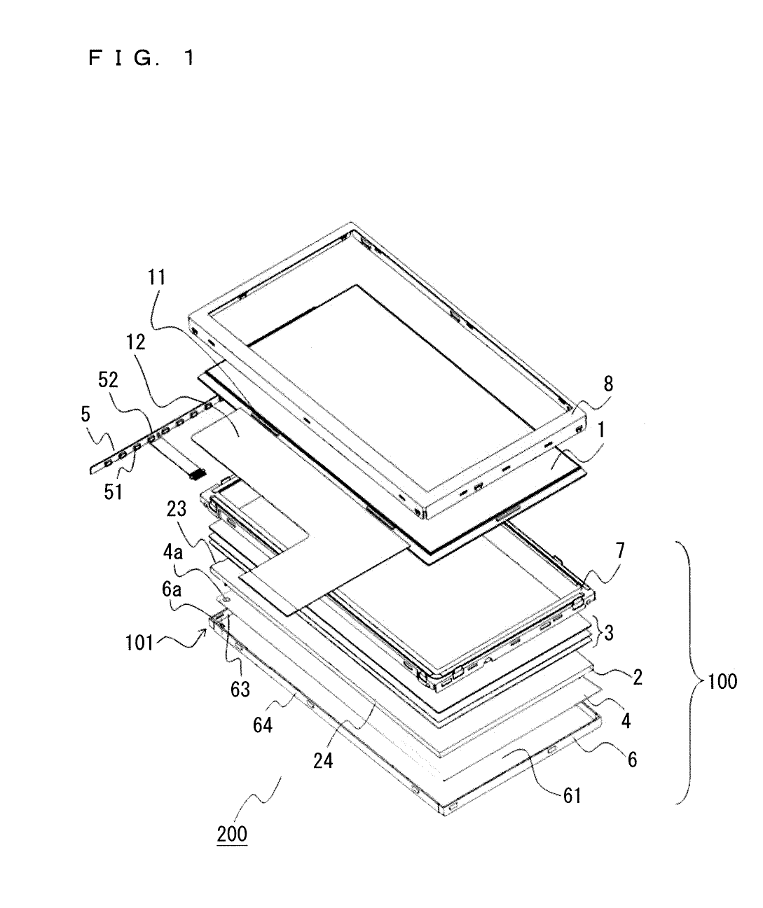

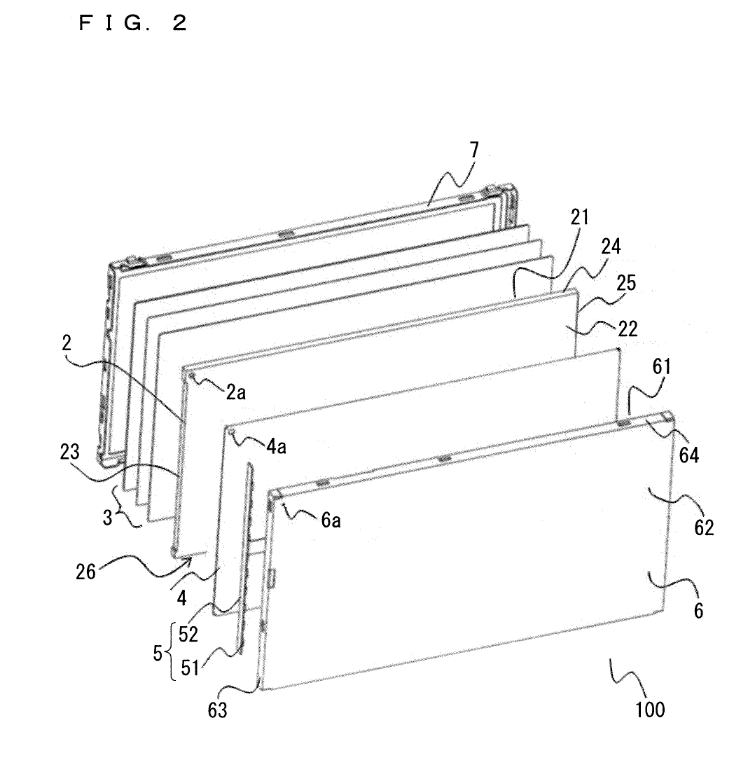

FIG. 1 is an exploded perspective view showing a schematic configuration of the display device according to the present invention, and FIG. 2 is an exploded perspective view of the planar light source device according to the present invention.

In FIGS. 1 and 2, a display device 200 according to the present invention is configured from a display panel 1 and a planar light source device 100. A liquid crystal display panel is used as the display panel 1, for example. The liquid crystal display panel includes a glass substrate on which wirings and electrodes are formed and a counter substrate, which are disposed in parallel to each other, and a liquid crystal is sandwiched between the substrates, and a polarizer is attached to a surface of each substrate (not shown). Furthermore, a display region of the liquid crystal display panel 1 is formed from a large number of pixels, and an image is displayed when a signal according to a display image is applied to each pixel by a drive IC 11 and a circuit board 12.

The planar light source device 100 includes a light guide plate 2 for guiding light in a planar manner and emitting the light from an emitting surface 21, and the light guide plate 2 is disposed in a rear frame 6 including an opening portion 61. The light guide plate 2 emits light in a direction of the opening portion 61, and the direction is made an emission direction. The light guide plate 2 includes an emitting surface 21 for emitting light, a counter-emitting surface 22 which is a surface of the light guide plate 2 opposite the emitting surface 21, and side surfaces 23, 24, 25, 26 which are substantially perpendicular to the emitting surface 21 and the counter-emitting surface 22 of the light guide plate 2 and which connect the emitting surface 21 and the counter-emitting surface 22. Additionally, the light guide plate 2 used in the present preferred embodiment is a flat plate which is rectangular in a plan view, and includes a pair of first side surfaces 23, 25 facing each other and a pair of second side surfaces 24, 26 facing each other. Furthermore, point light sources 51 for emitting light form a light source unit 5 mounted on a light source substrate 52, and the light source unit 5 is disposed facing the first side surface 23 of the light guide plate 2. Optical sheets 3, such as a lens sheet and a diffusion sheet for diffusing light, are disposed on the emitting surface 21 side of the light guide plate 2. Moreover, a reflective sheet 4 is disposed on the counter-emitting surface 22 of the light guide plate 2. The light guide plate 2, the optical sheets 3, the reflective sheet 4, and light source unit 5 are held by being sandwiched between the rear frame 6 and an intermediate frame 7 facing the rear frame 6.

With the display device 200 according to the present invention, the display panel 1, such as a liquid crystal panel, is held by the intermediate frame 7 and is sandwiched between a front frame 8 and the planar light source device 100.

<Light Guide Plate>

In the present invention, the light guide plate 2 is a flat plate which is substantially rectangular in a plan view and which has a constant thickness, but a wedge-shaped light guide plate 2 may alternatively be used. Moreover, a shape other than a substantially rectangular shape, such as a polygonal shape, may also be used. The material is a transparent acrylic resin, a polycarbonate resin, glass or the like. Furthermore, a light scattering section (not shown) for disturbing a propagation direction of light and for guiding light to be emitted from the emitting surface 21 of the light guide plate 2 is formed on the counter-emitting surface 22 side of the light guide plate 2. The light scattering section functions as means for reflecting light toward an inside of the light guide plate 2. As the means for reflection, a method of performing dot-printing on the counter-emitting surface 22, a method of roughening the counter-emitting surface 22 and forming a grained surface, or a method of forming fine spherical patterns or protrusions and recesses is conceivable, for example.

<Optical Sheet>

A lens sheet, a diffusion sheet and the like may be disposed in combination as the optical sheets 3. Alternatively, a structure may be used according to which a lens sheet is sandwiched by diffusion sheets. Moreover, a plurality of lens sheets with an optimum combination of prism directions may be used to enhance brightness. Two or more diffusion sheets may be used to improve a diffusion property of the diffusion sheet. A case where only one diffusion sheet is used, and a case where the diffusion sheet is not used are also possible. Moreover, the optical sheets 3 may include a protective sheet, a viewing angle control sheet, or a polarizing reflective sheet. That is, a combination according to desired brightness or light distribution characteristics is used as the optical sheets 3.

<Reflective Sheet>

As the reflective sheet 4, a material mixing barium sulfate or titanium dioxide with polyethylene or polyethylene terephthalate, a material obtained by forming fine bubbles in resin, a material obtained by performing vapor deposition of silver on a metal plate, or a material obtained by applying a coating containing titanium dioxide on a metal plate is used. Additionally, reflectance of the reflective sheet 4 is desirably at least 90% to suppress a reflection loss at a reflecting surface, and a material which achieves specular reflection may be used. By disposing the reflective sheet 4, light emitted from the light guide plate 2 may be directed again towards the light guide plate 2 to enter the light guide plate 2, and a light utilization efficiency may be increased.

<Light Source Unit>

The light source unit 5 is configured by the light source substrate 52 on which the point light sources 51 for emitting light are mounted. A frame formed from a metal material may be provided on a rear surface of the light source unit 5. Furthermore, the optical unit 5 may be disposed by being fixed to a side surface of the rear frame 6.

<Rear Frame, Intermediate Frame>

When a metal material such as aluminum or a material containing metal is used for the rear frame 6, a heat dissipation performance of the point light sources 51 may be enhanced, a loss in light may be suppressed, and a light utilization efficiency of the planar light source device 100 may be increased. In the present preferred embodiment, a metal material is used for the rear frame 6. The rear frame 6 is a substantially box-shaped frame including the opening portion 61 opposite a bottom surface 62, and side surfaces 63, 64, 65, 66 which are formed continuously to the bottom surface 62, and an optical member is held inside. The intermediate frame 7 is formed of resin or a metal material, and is engaged with the rear frame 6 to sandwich the optical member mentioned above.

<Front Frame>

The front frame 8 includes an opening portion for allowing the display panel 1 to be viewed from outside. Rigidity of the display device 200 is increased by using a metal material such as SUS or aluminum for the front frame 8, for example.

<Light Guide Plate, Planar Light Source Device>

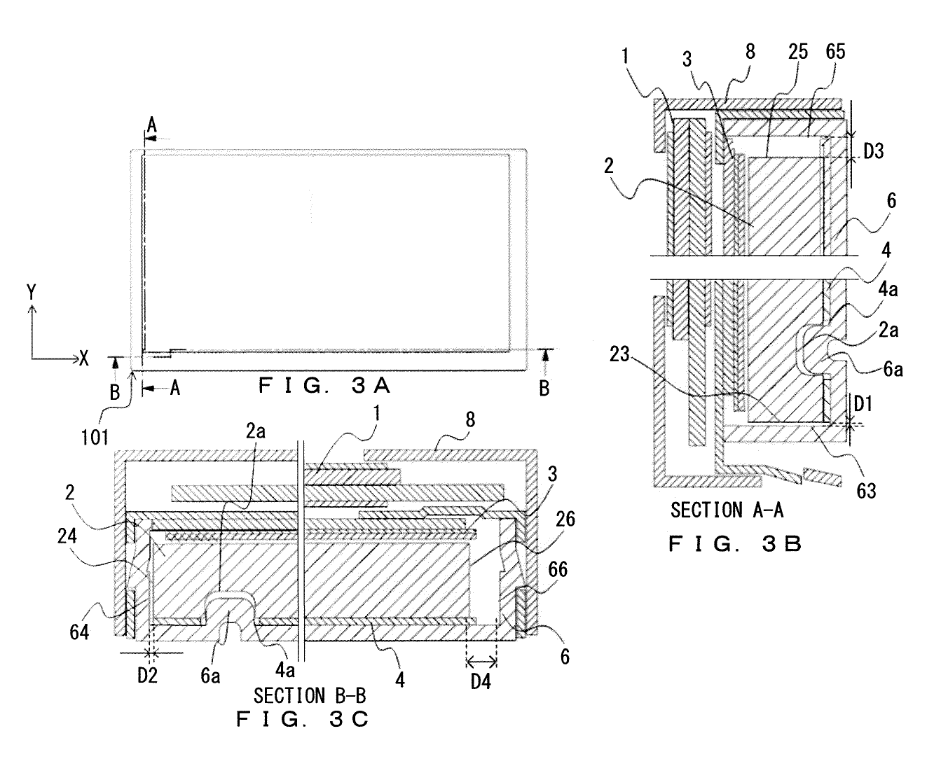

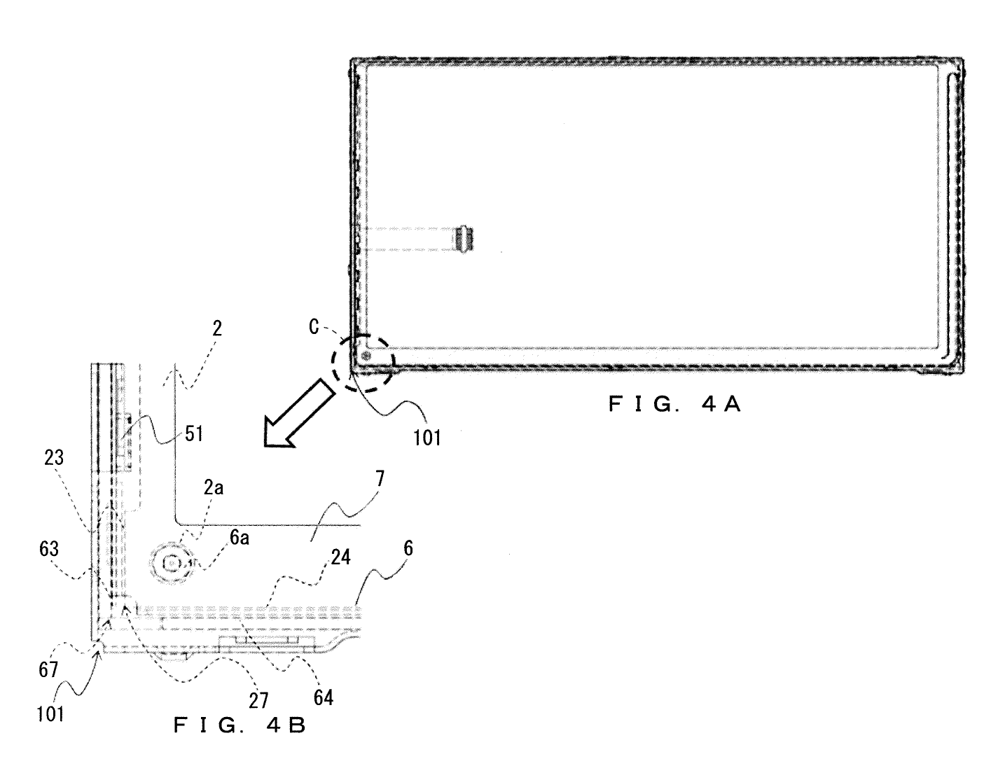

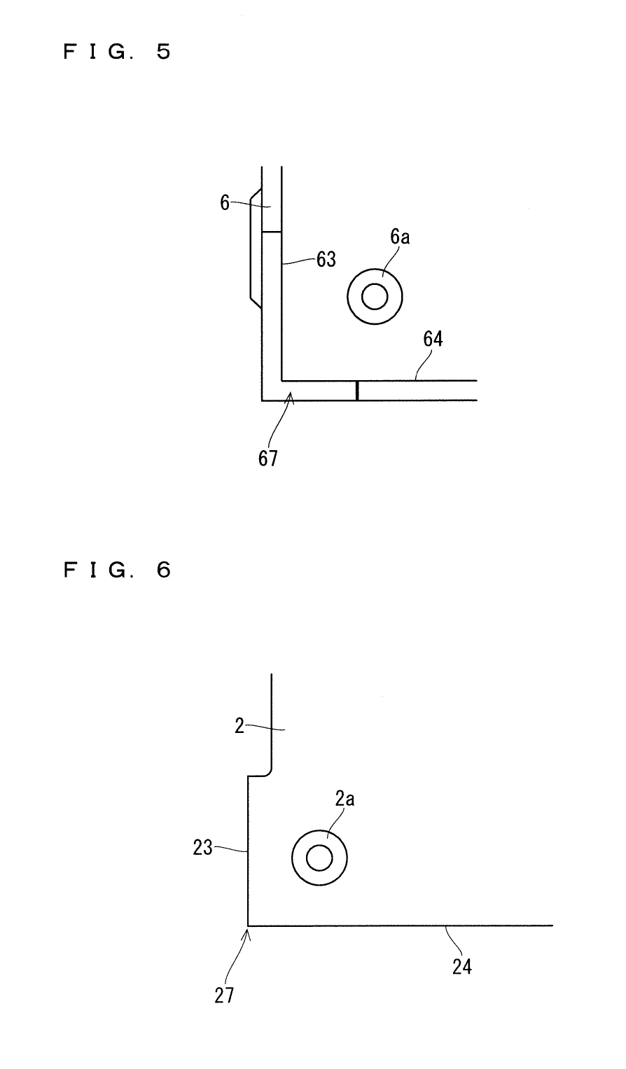

FIG. 3A is a front view of the display device according to the present invention, FIG. 3B is a cross-sectional view in a direction of line A-A in the front view in FIG. 3A, and FIG. 3C is a cross-sectional view in a direction of line B-B in the front view in FIG. 3A. FIG. 4A is a front view of the planar light source device, and FIG. 4B is an enlarged view of main parts at a portion C in FIG. 4A, FIG. 5 is an enlarged view of main parts of the rear frame disposed at the portion C in FIG. 4A, and FIG. 6 is an enlarged view of main parts of the light guide plate disposed at the portion C in FIG. 4A.

As shown in FIGS. 3A to 3C and FIGS. 4A and 4B, an engagement structure for the rear frame 6 and the light guide plate 2 is formed near one corner portion 101 of the planar light source device 100. Additionally, a description will be given taking a left-right direction as viewed in FIGS. 3A to 3C as an X-direction, and an up-down direction as a Y-direction.

As shown in FIG. 5, the rear frame 6 includes a corner portion 67 which includes two continuous side surfaces of the rear frame 6 and which is formed from the side surface 63 and the side surface 64. A protruding portion 6a protruding from the bottom surface 62 towards an inside of the rear frame 6 is formed near the corner portion 67. Furthermore, as shown in FIG. 6, the light guide plate 2 includes a corner portion 27 which includes two continuous side surfaces and which is formed from the side surface 23 and the side surface 24, and a recessed portion 2a of the light guide plate 2 is formed at a position corresponding to a position where the protruding portion 6a of the rear frame 6 is formed. Moreover, as shown in FIGS. 3B and 3C, the reflective sheet 4 is disposed on the counter-emitting surface of the light guide plate 2, and a hole portion 4a for allowing penetration of the protruding portion 6a is formed at a position of the reflective sheet 4 corresponding to a position of the protruding portion 6a.

The engagement structure for the rear frame 6, the light guide plate 2, and the reflective sheet 4 will be described with reference to FIGS. 3A to 3C to FIG. 6. The hole portion 4a formed to the reflective sheet 4 is arranged at the protruding portion 6a formed to the rear frame 6, and the reflective sheet 4 is thereby held. Furthermore, the light guide plate 2 is fixed by having the recessed portion 2a engaged with the protruding portion 6a formed to the rear frame 6. Additionally, a clearance between the protruding portion 6a of the rear frame 6 and the recessed portion 2a of the light guide plate 2 is designed to be 0.05 mm in a state where there is no change in temperature.

Moreover, the protruding portion 6a of the rear frame 6 and the recessed portion 2a of the light guide plate 2 are provided at one position near the corner portion 101 of the planar light source device 100. The corner portion 67 of the rear frame 6 facing the corner portion 101 is arranged in correspondence with the corner portion 27 of the light guide plate 2. Furthermore, the side surface 23 and the side surface 24 of the light guide plate 2 are arranged in correspondence with the side surface 63 and the side surface 64. Additionally, a clearance between the side surface 63 and the side surface 23 is indicated by D1, and a clearance between the side surface 64 and the side surface 24 is indicated by D2. Moreover, a clearance between the side surface 65 and the side surface 25 is indicated by D3, and a clearance between the side surface 66 and the side surface 26 is indicated by D4.

The protruding portion 6a of the rear frame 6, the recessed portion 2a of the light guide plate 2, and the hole portion 4a of the reflective sheet 4 forming the present engagement structure are formed at one position near the corner portion 101 of the planar light source device 100. When the light guide plate 2 and the reflective sheet 4 are positioned at the protruding portion 6a of the rear frame 6 and are incorporated, the side surfaces 23, 24 of the light guide plate 2 formed in correspondence with the side surfaces 63, 64 of the rear frame 6 close to the protruding portion 6a are arranged facing the side surfaces 63, 64, and thus, the side surface 63, 64 of the rear frame 6 and the side surface 23, 24 of the light guide plate 2 are positioned with a minimum clearance D1 or D2 and are fixed closed to each other. Other optical members (such as the reflective sheet 4) may be disposed in the clearance D1 or D2. Additionally, the clearance D1 or D2 may be made zero. That is, the side surfaces of the light guide plate 2 and the rear frame 6 may be in contact with each other. As described above, the side surface 23 of the light guide plate 2 is arranged close to or in contact with the side surface 63 of the rear frame 6. Similarly, the side surface 24 of the light guide plate 2 is arranged close to or in contact with the side surface 64 of the rear frame 6. Additionally, a distance according to an amount of expansion which is caused by a change in temperature of the light guide plate 2 and the optical sheets 3 is secured by the clearance D1 and the opposite clearance D3, and the clearance D2 and the clearance D4 between the side surfaces of the light guide plate 2 and the rear frame 6 formed opposite the clearance D2. Additionally, when the clearance between the protruding portion 6a and the recessed portion 2a is given as d, the clearances D1, D2 are preferably set to d to 2d, and the clearances D3, D4 to 6d to 20d.

As described above, the planar light source device 100 according to the present invention includes the engagement structure for the light guide plate 2 and the rear frame 6. At the time of engagement between the protruding portion 6a of the rear frame 6 and the recessed portion 2a of the light guide plate 2, two continuous side surfaces forming the corner portion 67 where the protruding portion 6a of the rear frame 6 is disposed, that is, the side surface 63 and the side surface 64, are arranged in contact with or close to the corresponding side surface 23 and side surface 24 of the light guide plate 2 in a manner facing the side surface 23 and the side surface 24. According to the present structure, even in a use environment where a temperature range is wide and in a use environment where vibration or impact is constantly applied, the light guide plate 2 may be prevented from moving in the X-direction and the Y-direction, because the recessed portion 2a formed to the light guide plate 2 is engaged with the protruding portion 6a of the rear frame 6, and the side surface 23 near the recessed portion 2a and the side surface 63 near the protruding portion 6a, and the side surface 24 near the recessed portion 2a and the side surface 64 near the protruding portion 6a are arranged close to or in contact with each other.

Furthermore, the engagement structure according to the present invention is formed at the corner portion 101 of the planar light source device 100, and the side surface 23 of the light guide plate 2 and the side surface 63 of the rear frame 6 are arranged facing each other, and thus, in a case where the light guide plate 2 is disposed close to the side surface 63 of the rear frame 6 facing the side surface 23, even if the side surface 23 is moved due to application of a force of moving the light guide plate 2 in a rotation direction, the side surface 23 comes into contact with the side surface 63 and its movement is prevented. Moreover, in a case where the light guide plate 2 is in contact with the side surface 63 of the rear frame 6 facing the side surface 23, movement of the light guide plate 2 is prevented. Furthermore, in the same manner, in a case where the light guide plate 2 is disposed close to the side surface 64 of the rear frame 6 facing the side surface 24, even if the side surface 24 is moved, the side surface 24 comes into contact with the side surface 64 and its movement is prevented. Moreover, in a case where the light guide plate 2 is in contact with the side surface 64 of the rear frame 6 facing the side surface 24, movement of the light guide plate 2 is prevented. Accordingly, with the planar light source device 100 according to the present invention, movement of the light guide plate 2 in the X-direction, the Y-direction, and the rotation direction may be prevented.

As described above, the planar light source device 100 according to the present invention may prevent movement of the light guide plate 2 in the X-direction, the Y-direction, and the rotation direction even in a use environment where a temperature range is wide and in a use environment where vibration or impact is constantly applied. Therefore, rattle noise which is caused by wobbling between the light guide plate and a peripheral member may be suppressed even in a use environment where a temperature range is wide and in a use environment where vibration or impact is constantly applied.

Furthermore, the light guide plate 2 may be stably fixed and held for a long time without being peeled off as in the case of fixation by a double-sided adhesive tape or a cushioned adhesive tape.

Furthermore, unlike in the case of fixation by a double-sided adhesive tape or a cushioned adhesive tape, a region for fixation is not necessary, and a frame border size of the display device 200 may be reduced.

Moreover, unlike the method of fixing by a double-sided adhesive tape or a cushioned adhesive tape, assembly and disassembly of the light guide plate 2 may be easily performed, and members can be re-used.

Additionally, a frame border of the display device 200 may be reduced, because a structure such as an ear portion which is used for holding does not have to be provided to the light guide plate 2, and the protruding portion 6a of the rear frame 6 is provided on a side of the display panel 1 where the drive IC 11 is mounted or on a side where the light source unit 5 is disposed.

Furthermore, the protruding portion 6a is formed by performing a drawing process, a dowel forming (protrusion forming) process or the like on the rear frame 6, and positioning of the light guide plat 2 at a predetermined position is physically performed, and thus, a change in brightness caused by a change in the distance between the light source unit 5 and the light guide plate 2 may be suppressed, and the planar light source device 100 may achieve a small change in brightness.

Furthermore, the present invention is not limited to the configuration of the preferred embodiment described above, and various changes or combinations are possible within the scope of the present invention. Furthermore, the types, the arrangement positions and the like of the point light source and the light guide plate may be selected as appropriate.

While the invention has been shown and described in detail, the foregoing description is in all aspects illustrative and not restrictive. It is therefore understood that numerous modifications and variations can be devised without departing from the scope of the invention.

What is claimed is:

1. A planar light source device comprising:
a light source;
a light guide plate for emitting light from the light source from an emitting surface, the light guide plate including at least two side surfaces that are continuous to the emitting surface; and
a frame for housing on an inside the light source and the light guide plate, the frame including a bottom surface and side surfaces that are continuous to the bottom surface, wherein
the frame includes, near a corner portion formed by two of the side surfaces, a protruding portion protruding toward the inside from the bottom surface,
a recessed portion for engaging with the protruding portion is formed to the light guide plate, on a counter-emitting surface opposite the emitting surface of the light guide plate and at a position where the protruding portion is disposed, and
at least two of side surfaces of the light guide plate are arranged facing the two side surfaces forming the corner portion of the frame.

2. The planar light source device according to claim 1, wherein the side surfaces of the light guide plate and the side surfaces of the frame are arranged in contact with or close to each other.

3. The planar light source device according to claim 1, wherein the protruding portion formed to the frame is formed near a position where the light source is disposed.

4. The planar light source device according to claim 1, further comprising a reflective sheet for reflecting light to the counter-emitting surface of the light guide plate, wherein
the reflective sheet includes a hole portion at a position corresponding to a position where the protruding portion of the frame is formed.

5. A display device comprising a display panel for displaying an image, the display panel facing the planar light source device according to claim 1.

6. The planar light source device according to claim 2, wherein the protruding portion formed to the frame is formed near a position where the light source is disposed.

7. The planar light source device according to claim 2, further comprising a reflective sheet for reflecting light to the counter-emitting surface of the light guide plate, wherein
the reflective sheet includes a hole portion at a position corresponding to a position where the protruding portion of the frame is formed.

8. A display device comprising a display panel for displaying an image, the display panel facing the planar light source device according to claim 2.

9. The planar light source device according to claim 3, further comprising a reflective sheet for reflecting light to the counter-emitting surface of the light guide plate, wherein
the reflective sheet includes a hole portion at a position corresponding to a position where the protruding portion of the frame is formed.

10. A display device comprising a display panel for displaying an image, the display panel facing the planar light source device according to claim 3.

11. A display device comprising a display panel for displaying an image, the display panel facing the planar light source device according to claim 4.
